(19) United States
(12) Patent Application Publication
(10) Pub. No.: US 2026/0012032 A1
(43) Pub. Date: Jan. 8, 2026

(54) DEVICE AND METHOD FOR CONTROLLING THE DISCHARGE OF A DC LINK CAPACITOR

(71) Applicant: Robert Bosch GmbH, Stuttgart (DE)

(72) Inventor: Ekard Grossmann, Stuttgart (DE)

(21) Appl. No.: 18/993,643

(22) PCT Filed: May 9, 2023
(86) PCT No.: PCT/EP2023/062262

§ 371 Date: Jan. 13, 2025

(30) Foreign Application Priority Data
Jul. 14, 2022 (DE) 10 2022 207 196.4

(51) Int. Cl. H02J 7/00; H02J 7/34

(52) U.S. Cl. CPC H02J 7/00712; H02J 7/345

(57) ABSTRACT

The invention relates to activating an active discharge of a DC link capacitor. To this end, provision is made of a discharge device which can detect a condition for activating the discharge of a DC link capacitor independently of other system components and thus can initiate an active discharge of the DC link capacitor. To this end, the voltage across the DC link capacitor is evaluated and the active discharge of the DC link capacitor is enabled if a gradient of the voltage across the DC link capacitor falls below a predefined threshold value.

### BACKGROUND

The present invention relates to a device and method for controlling the discharge of a DC link capacitor, a device for discharging a DC link capacitor, an electrical power converter, and an electrical drive system.

Electrical power converters for converting an input voltage into an output voltage are used in numerous applications. Such power converters are used in electric drive systems, for example, as can also be found in electric vehicles, among other things. In this case, an input DC voltage of usually several hundred Volts is converted by the power converter into an output voltage for controlling an electric machine. A so-called DC link capacitor is provided to stabilize the input DC voltage.

To avoid potential hazards that may arise from a charged DC link capacitor in an accident or during repairs, this DC link capacitor is intentionally discharged when the electric drive system is turned off or disabled.

Publication DE 10 2013 224 884 A1 describes, for example, a device and a method for discharging such a DC link capacitor. A discharge controller is provided, which discharges the DC link capacitor via an electrical load having a predefined discharging current.

### SUMMARY

The present invention relates to a device and method for controlling the discharge of a DC link capacitor, a device for discharging a DC link capacitor, an electrical power converter, and an electrical drive system with the feature of the independent claims. Further advantageous embodiments are the subject matter of the dependent claims.

The following is therefore provided:

A device for controlling the discharge of a DC link capacitor with a monitoring device and a control device. The monitoring device is configured to determine a voltage across the DC link capacitor. The control device is configured to determine a time gradient of the voltage across the DC link capacitor. Furthermore, the control device is configured to enable an active discharge of the DC link capacitor if the gradient of the voltage across the DC link capacitor falls below a predefined first threshold value.

The following is furthermore provided:

A device for discharging a DC link capacitor having a passive discharge path, an active discharge path, and a device according to the present invention for controlling the discharge of the DC link capacitor. The passive discharge path comprises an electrical resistance and/or an electrical consumer between a first port of the DC link capacitor and a second port of the DC link capacitor. The active discharge path comprises a switching element between the first port of the DC link capacitor and the second port of the DC link capacitor. In particular, the active discharge path may comprise a series circuit consisting of the switching element and a further electrical resistance and/or a further electrical consumer. The device for controlling the discharge of the DC link capacitor is configured to close the switching element in the active discharge path if the active discharge of the DC link capacitor is enabled.

The following is furthermore provided:

An electrical power converter having an input terminal, a DC link capacitor, an output terminal and a device according to the invention for discharging the DC link capacitor. The input terminal is configured so as to be connected to a DC power source. The DC link capacitor is arranged between a first connection point and a second connection point of the input terminal. In particular, the power converter is configured to convert a DC voltage supplied to the input terminal into a predefined output voltage and to supply that output voltage to the output terminal.

In addition, the following is provided:

An electrical drive system with an electric machine and an electrical power converter according to the invention. The electric machine is electrically connected to the output terminal of the power converter.

Finally, the following is provided:

A method for controlling the discharge of a DC link capacitor with a step of determining an electrical voltage across the DC link capacitor, a step for determining a time gradient of the voltage across the DC link capacitor, and a step for enabling an active discharge of the DC link capacitor, if the temporal gradient of the voltage across the DC link capacitor falls below a predefined first threshold value.

DC link capacitors, such as those found in electric power converters, may continue to store electrical energy even after the active operation of the power converter has been switched off, so that a relatively high voltage may possibly be present over an extended period of time across the DC link capacitor. To avoid potential hazards that may arise from such a high voltage, it is desirable to discharge the DC link capacitor as quickly as possible once the electrical power converter is disabled.

While such active discharging of the DC link capacitor may generally be initiated by a controller of the power converter, for example, it is also necessary or at least desirable to provide a discharge of the DC link capacitor independent of this controller. Thus, even in the event of a failure or a malfunction of the controller for the power converter, a rapid and reliable discharge of the DC link capacitor may be ensured by an additional device independent of the actual controller.

However, this requires that such a system, which is independent of the actual controller, also detects an operating state as quickly and reliably as possible in which the DC link capacitor can be discharged.

The present invention makes use of the fact that when the power converter is switched off and the associated disconnection of the power converter from an input voltage source, the voltage decreases continuously over time across the DC link capacitor. This is usually supported by an electrical resistance provided in parallel with the DC link capacitor in a passive discharge branch. This continuous drop of voltage mathematically corresponds to a negative gradient of the voltage across the DC link capacitor. In other words, if the gradient of the voltage across the DC link capacitor has a negative value whose amount exceeds a predefined threshold value, this may be interpreted as an indication that the electric power converter is disabled. In such a case, therefore, an active discharge of the DC link capacitor may be initiated.

By monitoring the voltage across the DC link capacitor, a simple and at the same time very reliable option is available to be able to make a decision as to whether an active discharge of the DC link capacitor is to be initiated. In particular, a decision to actively discharge the DC link capacitor can be made in this way, which is completely independent of the control of the power converter itself. Thus, even if this control of the power converter malfunctions, an active discharge of the DC link capacitor may be initiated by an independent instance. This can increase the safety of the entire system.

A simple voltage sensor is sufficient to detect the voltage across the DC link capacitor. For example, an electrical voltage divider in the form of a series circuit of a plurality of electrical resistors can also be used for this purpose. If necessary, such a resistive divider may also be combined with the electrical resistances in the passive discharge branch to detect the electrical voltage across the DC link capacitor. Furthermore, any other options for detecting the electrical voltage across the DC link capacitor are of course also possible.

For example, to determine the gradient of the voltage across the DC link capacitor, the voltage curve may be analyzed within a predefined time interval. For example, a current voltage across the DC link capacitor may be compared to the voltage across the DC link capacitor before a predefined period of time, for example one second, and a voltage gradient may be calculated therefrom. However, any other suitable time intervals are generally possible. It is also possible, for example, to perform time filtering of the voltage curve in order to eliminate short-term voltage peaks, if necessary.

The evaluation of the voltage curve across the DC link capacitor can be carried out in any suitable manner. For example, this may be done by means of a microcontroller, an application-specific integrated circuit, or in any other manner.

According to one embodiment, the control device is configured to enable the active discharge of the DC link capacitor only if at least a predefined time period has elapsed since a previous active discharge of the DC link capacitor. In this way, a minimum pause time may be provided between two consecutive active discharges. This can prevent, for example, the occurrence of a very dynamic progression of the voltage across the DC link capacitor in rapid succession, resulting in undesirable activations of the discharge of the DC link capacitor.

According to one embodiment, the control device is configured to also enable active discharge of the DC link capacitor if the voltage across the DC link capacitor drops below a predefined minimum voltage. For example, a minimum electrical input voltage may be specified as the threshold value for this minimum voltage. For example, this minimum electrical input voltage may correspond to a voltage expected at least at the input. For example, in the case of a battery-powered voltage converter, this may correspond to a minimum battery voltage, for example, the voltage of a discharged battery or a discharged battery under load. If the voltage across the DC link capacitor drops below such a minimum voltage, it can be assumed that the DC link capacitor is disconnected from the voltage source and thus the requirements for discharging the DC link capacitor can be met.

According to one embodiment, the control device is configured to determine a speed of an electric machine in an electric drive system with the DC link capacitor. In that case, the control device may be configured to enable the active discharge of the DC link capacitor if the determined speed is below a predefined speed. For example, if a value of zero is used as the predefined minimum speed, this corresponds to a stoppage of the electric machine. Alternatively to a speed of zero, a speed may also be selected at which an induced voltage produced by the electric machine is less than a predefined maximum amplitude value. For example, this predefined maximum value may correspond to a value that is less than or equal to a maximum allowable voltage of the discharged DC link capacitor.

According to one embodiment, the control device is configured to stop the active discharge of the DC link capacitor if the temporal gradient of the voltage across the DC link capacitor exceeds a predefined second threshold value. For example, the predefined second threshold may correspond to the first predefined threshold for enabling the active discharge. Alternatively, the two threshold values may differ, such that, for example, hysteresis is provided between the first and second threshold values. If the temporal gradient of the voltage across the DC link capacitor exceeds this second threshold value, this may be an indication, for example, that the conditions for an active discharge of the DC link capacitor are currently not met in the system with the DC link capacitor. For example, a previous undershoot of the gradient of the voltage across the DC link capacitor may be caused by a relatively heavy load. In such cases, a voltage drop across the DC link capacitor may be subsequently balanced by a connected voltage source. This increases the gradient of the voltage across the DC link capacitor. In such a case, it may be determined that a potentially initiated discharge of the DC link capacitor is not appropriate, and as a result, the discharge of the DC link capacitor may be stopped again.

According to one embodiment of the electric drive system, the device for controlling the discharge of the DC link capacitor is configured to enable the active discharge of the DC link capacitor only if a predefined operating state is set by the power converter. The operating states in which an active discharge of the DC link capacitor can be enabled can be so-called safe operating states, such as an active short-circuit or a free-wheel run, for example. In this way, it can be ensured that no active discharge of the DC link capacitor occurs as long as the drive system is in an operation mode to control the electric machine, in which the electric machine is actively operated as a motor or generator.

The above embodiments and further developments can be combined with one another in any desired manner insofar as advantageous. Additional embodiments, further developments, and implementations of the invention also include inventive feature combinations not described or explicitly specified hereinabove or hereinafter with respect to exemplary embodiments. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1: a schematic representation of a principle block diagram of an electrical drive system comprising a device for controlling the discharge of a DC link capacitor according to one embodiment;

FIG. 2: a voltage-time diagram illustrating the control of the discharge of a DC link capacitor according to one embodiment;

FIG. 3: a voltage-time diagram illustrating the control of the discharge of a DC link capacitor according to a further embodiment; and

FIG. 4: a flow chart on which a method for controlling the discharge of a DC link capacitor according to one embodiment is based.

### DETAILED DESCRIPTION

FIG. 1: a schematic representation of a principle block diagram of an electrical drive system comprising a device 1 for discharging a DC link capacitor according to one embodiment. The electrical drive system comprises a power converter 2 and an electrical machine 3 connected to the electric power converter 2. The electric power converter 2 can be supplied with electrical power at an input terminal from a voltage source 4. For example, the voltage source 4 may be a DC voltage source, in particular a battery such as the traction battery of an electric vehicle. The voltage source 4 can be disconnected from the input terminal of the power converter 2 by means of the switching elements 41, 42. To operate the electric drive system, the two switches 41, 42 are closed.

The electric power converter 2 can thus generate a voltage suitable for controlling the electric machine 3 using the electrical energy supplied by the voltage source 4. In a further mode of operation, the power converter 2 may convert a voltage generated by the electric machine 3 in generator operation into a voltage suitable for charging a battery 4 connected to the input terminal of the power converter 2.

To stabilize the input voltage, a DC link capacitor 20 is provided between the two connection points of the input terminal in the power converter 2. If the power converter 2 is disabled, a voltage can remain across a charged DC link capacitor 20 even if the two switching elements 41, 42 are opened. In such a case, the DC link capacitor 20 may be discharged by means of the device 1 for discharging the DC link capacitor 20.

The device 1 for discharging the DC link capacitor 20 comprises an active discharge path and a passive discharge path. In the passive discharge path, an electrical resistor 12 is provided between the two connection points of the input terminal of the power converter 2. It is understood that instead of a single electrical resistor 12, a series circuit and/or parallel circuit of a plurality of electrical resistors may also be provided. An electrical current therefore always flows through this electrical resistance 12 in the passive discharge path as long as a voltage is present across the DC link capacitor 20. As a result, the DC link capacitor 20 is continuously discharged with a relatively low discharge current.

In the active discharge path, a switching element 13 is provided between the two connection points of the DC voltage connection of the power converter 2. Furthermore, at least one electrical resistor 14 may be provided in series to this switching element 13. This electrical resistance 14 can be used to limit the discharge current upon active discharge of the DC link capacitor 20. The switching element 13 is closed for this active discharge of the DC link capacitor 20. For example, the switching element 13 can be controlled by a control device 11 to initiate an active discharge of the DC link capacitor 20. For example, the electrical resistors 12 and 14 in the passive and active discharge path may be embodied as ohmic resistors. However, in addition or alternatively, it is also possible to provide another suitable electrical consumer. In particular, a controlled discharge of the DC link capacitor 20 via the power converter 2, in particular via so-called hot branches of the power converter 2, can also be included as an electrical consumer.

The control device 11 can in particular operate independently of further components of the electric drive system, for example a control circuit for controlling the power converter 2. The discharge of the DC link capacitor 20 can thus also be activated if a malfunction should occur in the further components of the drive system.

The control device 11 of the device 1 for discharging the DC link capacitor 20 can detect the voltage across the DC link capacitor 20. For example, a current sensor may be provided for monitoring the electrical current. The control device 11 can continuously monitor the voltage across the DC link capacitor 20. For example, it is also possible to periodically detect the voltage across the DC link capacitor 20 at predefined time intervals and to evaluate it as explained below.

The control device 11 evaluates the electrical voltage across the DC link capacitor 20 and, using the measured value of the voltage across the DC link capacitor 20, controls the switching element 13 in the active discharge path of the device 1 for discharging the DC link capacitor 20 to enable or disable an active discharge of the DC link capacitor 20.

For example, a gradient of this time curve of the voltage across the DC link capacitor 20 can be determined from the time curve of the electrical voltage across the DC link capacitor 20. This gradient corresponds to the change in electrical voltage across the DC link capacitor 20 over time. A negative gradient corresponds to a decrease in the voltage across the DC link capacitor 20, while a positive gradient corresponds to an increase in the electrical voltage across the DC link capacitor 20.

If the DC link capacitor 20 of the power converter 2 is disconnected from the voltage source 4, for example by opening the switching elements 41, 42, the voltage across the DC link capacitor 20 will drop over time as the DC link capacitor 20 is discharged via the passive discharge path with the electrical resistor 12. Thus, the control device 11 of the device 1 for discharging the DC link capacitor 20 can detect this drop in the voltage and subsequently enable an active discharge of the DC link capacitor 20 via the active discharge path. For this purpose, the control device 11 can detect, for example, that the gradient of the curve of the electrical voltage across the DC link capacitor 20 has a negative value that is below a predefined threshold value. In other words, the amount of a negative gradient exceeds a threshold value. The threshold value below which the negative gradient of the voltage curve of the voltage across the DC link capacitor 20 should fall below before an active discharge is triggered should be selected, for example, as a function of the discharge current through the passive discharge path with the electrical resistor 12.

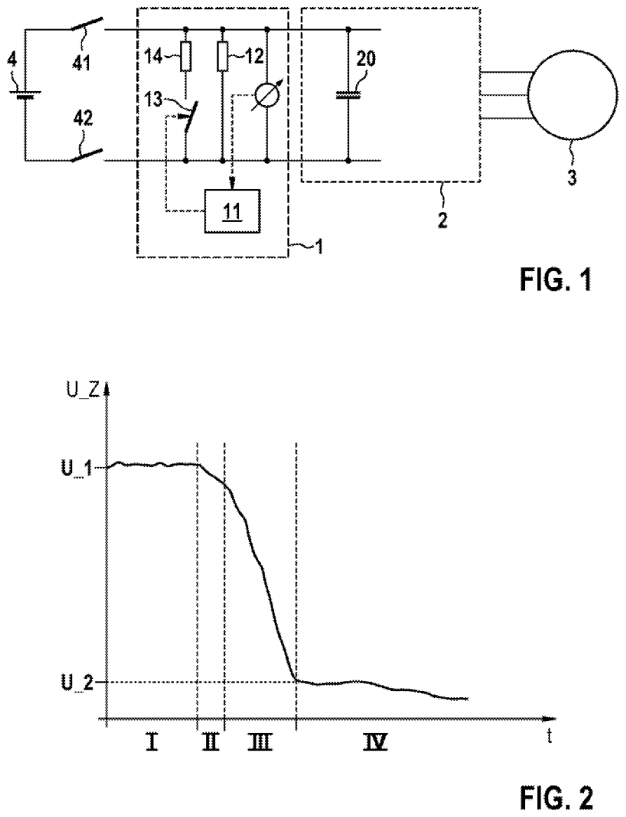

FIG. 2 shows a schematic representation of a voltage-time diagram illustrating the principle previously described for enabling an active discharge of the DC link capacitor 20. For example, in a first section I, the electric drive system is in a normal operating state. During this normal operating state, the electric drive system is supplied with electrical power from a voltage source 4, for example, such that the voltage U_Z across the DC link capacitor 20 is at least approximately constant at a value of approximately U_1. If the connection between the voltage source 4 and the input terminal of the power converter 2 is opened, for example by opening the switching elements 41, 42, the voltage U_Z across the DC link capacitor 20 drops, as the DC link capacitor 20 is discharged via the passive discharge path with the electrical resistor 12. This drop in the electrical voltage U_Z across the DC link capacitor 20 in the second phase II and the associated negative gradient can be detected, for example, by the control device 11. If the gradient of the voltage U_Z across the DC link capacitor 20 falls below a predefined threshold value, the control device 11 then enables the active discharge and closes the switching element 13 in the active discharge path. Then, in the third phase III, the DC link capacitor 20 is discharged via the active discharge path with the switching element 13 and the electrical resistance 14. This discharge operation is in particular maintained until the voltage U_Z across the DC link capacitor 20 drops below a predefined maximum value U_2 of, for example, 60 Volts. The active discharge of the DC link capacitor 20 can then be ended and the switching element 13 can be opened again in the active discharge path, so that in section IV the voltage permanently falls below the maximum allowable value U2.

In addition to evaluating the gradient in the voltage curve of the voltage U_Z across the DC link capacitor 20, it is also possible to additionally take into account the absolute value of the voltage U_Z across the DC link capacitor 20 for activating an active discharge of the DC link capacitor 20. If the voltage U_Z across the DC link capacitor 20 falls below a previously specified minimum voltage, for example, this can also be interpreted as an indication that the input of the power converter 2 and thus the DC link capacitor 20 is not electrically connected to a voltage source 4. For example, this minimum voltage may correspond to a minimum battery voltage, in particular a minimum battery voltage under load, if the electric power converter 2 is supplied by a voltage source 4 with a battery. For example, this minimum battery voltage may correspond to the minimum battery voltage of a discharged battery. If the voltage U_Z across the DC link capacitor 20 drops below this previously specified minimum voltage, this can also be interpreted as an indication that the input of the voltage converter 2 is not connected to the DC voltage source 4. Thus, in this case, an active discharge of the DC link capacitor 20 can also be enabled via the active discharge path with the switching element 13.

Furthermore, enabling the active discharge may also be subject to any further conditions. For example, an active discharge of DC link capacitor 20 may only be enabled if the electric machine 3 of the drive system is stationary or the speed of the electric machine 3 is below a predefined limit. For example, the maximum speed of the electric machine 3 can be selected as a speed at which the electric machine induces a voltage in a generator mode of operation whose peak value falls below a predefined maximum voltage value.

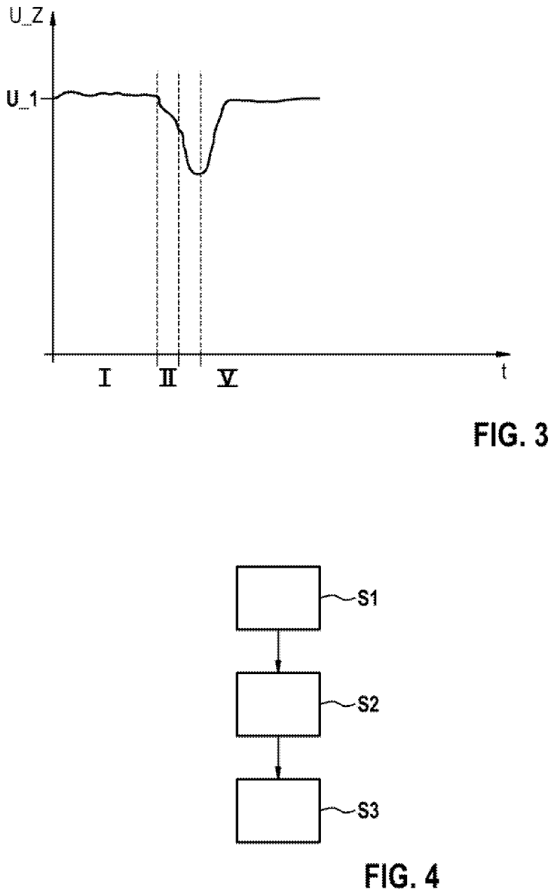

FIG. 3 shows a schematic representation of a voltage-time diagram of the voltage curve of the voltage U_Z across the DC link capacitor 20 according to another embodiment. Analogously to FIG. 2, during normal operation of the electric drive system in phase I, the voltage U_Z across the DC link capacitor 20 is at least approximately at a constant value U_1. If the voltage source 4 which feeds the input of the voltage converter 2, is very heavily loaded, for example by activating a large load, this can also cause the voltage U_Z at the input of the DC voltage converter 2 and thus over the DC link capacitor 20 to drop briefly and cause a corresponding negative gradient. This may lead to an undesirable activation of the active discharge of the DC link capacitor 20 in phase II. However, since the DC voltage source 4 continuously supplies further electrical energy, this brief voltage drop will be compensated very quickly and the voltage U_Z at the input of the voltage converter and thus across the DC link capacitor 20 will rise again to at least approximately to the original value U_1. In this case, control device 11 may detect a correspondingly high positive gradient of the electrical voltage across the DC link capacitor 20. In such a case, the active discharge of the DC link capacitor 20 may be stopped by re-opening the switching element 13. Thus, with such a voltage drop due to the activation of a large load, there will only be a brief activation of the active discharge of the DC link capacitor 20. In order to prevent undesired activation of the discharge of the DC link capacitor 20 too frequently in particularly dynamic systems, further activation of the active discharge of the DC link capacitor 20 can, for example, only be enabled if a predefined time period has elapsed since a previous activation of the active discharge.

FIG. 4 shows a flow chart on which a method for controlling a discharge of a DC link capacitor 20 according to one embodiment is based. In principle, the procedure can comprise any of the steps already described above in connection with the device 1 for discharging the DC link capacitor 20. Analogously, the device 1 described above for discharging the DC link capacitor 20 can also comprise any components that are necessary for implementing the method described hereinafter.

In a step S1, the electrical voltage U_Z is first detected via the DC link capacitor 20. A gradient of the time curve of the detected voltage U_Z across the DC link capacitor 20 can then be determined in step S2. If the gradient of the time curve of the voltage U_Z across the DC link capacitor 20 falls below a predefined threshold value, that is the amount of a negative gradient is greater than a corresponding positive threshold value, an active discharge of the DC link capacitor 20 is enabled. For example, for such an active discharge of the DC link capacitor 20, a switching element 13 in an active discharge path may be closed parallel to the connections of the DC link capacitor 20.

To evaluate the gradient of the time curve of the voltage U_Z across the DC link capacitor 20, time filtering of the measured values for the voltage U_Z across the DC link capacitor 20 may also be possible. For example, to determine the gradient of the voltage U_Z across the DC link capacitor 20, the variation of the voltage U_Z over a time interval of one second can be considered. However, any other suitable time intervals are generally possible.

In summary, the present invention elates to activating an active discharge of a DC link capacitor. To this end, provision is made of a discharge device which can detect a condition for activating the discharge of a DC link capacitor independently of other system components and thus can initiate an active discharge of the DC link capacitor. To this end, the voltage across the DC link capacitor is evaluated and the active discharge of the DC link capacitor is enabled if a gradient of the voltage across the DC link capacitor falls below a predefined threshold value.

1. A device for controlling a discharge of a DC link capacitor (20), comprising:
a monitoring device configured to determine a voltage (U_Z) across the DC link capacitor (20);
a control device (11) configured to determine a temporal gradient of the voltage (U_Z) across the DC link capacitor (20) and to enable an active discharge of the DC link capacitor (20) if the temporal gradient of the voltage (U_Z) across the DC link capacitor (20) falls below a predefined first threshold value.

2. The device according to claim 1, wherein the control device (11) is configured to enable the active discharge of the DC link capacitor (20) only if at least a predefined time period has elapsed since a previous active discharge of the DC link capacitor (20).

3. The device according to claim 1, wherein the control device (11) is configured to enable the active discharge of the DC link capacitor (20) if the voltage (U_Z) across the DC link capacitor (20) falls below a predefined minimum voltage.

4. The device according to claim 1, wherein the control device (11) is configured to determine a speed of an electric machine (3) in an electric drive system with the DC link capacitor (20) and to enable the active discharge of the DC link capacitor (20) if the determined speed is below a predefined speed value.

5. The device according to claim 1, wherein the control device is configured to stop the active discharge of the DC link capacitor if the temporal gradient of the voltage (U_Z) across the DC link capacitor (20) exceeds a predefined second threshold value.

6. The device (1) for discharging a DC link capacitor (20), comprising:
a passive discharge path arranged between a first port of the DC link capacitor (20) and a second port of the DC link capacitor (20) and comprising an electrical resistance (12) and/or an electrical consumer;
an active discharge path arranged between a first port of the DC link capacitor (20) and a second port of the DC link capacitor (20) and comprising a switching element (13); and
a device for controlling the discharge of the DC link capacitor (20) according to claim 1,
wherein the device for controlling the discharge is configured to close the switching element (13) in the active discharge path if the active discharge of the DC link capacitor (20) is enabled.

7. An electrical power converter (2), with:
an input port that is configured to be connected to a DC voltage source (4);
a DC link capacitor (20) arranged between a first connection point and a second connection point of the input terminal;
an output terminal;
a device (1) for charging the DC link capacitor (20) according to claim 6,
wherein the power converter (2) is configured to convert a DC voltage supplied to the input terminal into a predefined output voltage and supply it to the output terminal.

8. An electrical drive system, with:
an electrical power converter (2) according to claim 7; and
an electric machine (3) that is electrically connected to the output terminal of the power converter (2).

9. An electrical drive system according to claim 8, wherein the device for controlling the discharge of the DC link capacitor (2) is configured to enable the active discharge of the DC link capacitor (20) only if a predefined operating state is set by the power converter (2).

10. A method for controlling a discharge of a DC link capacitor (2), having the steps of:
determining (S1) an electrical voltage across the DC link capacitor (2);
determining (S2) a temporal gradient of the voltage (U_Z) across the DC link capacitor (2);
enabling (S3) an active discharge of the DC link capacitor (20) if the temporal gradient of the voltage across the DC link capacitor (20) falls below a predefined first threshold value.
